(19) United States
(12) Patent Application Publication
(10) Pub. No.: US 2005/0274049 A1
(43) Pub. Date: Dec. 15, 2005

(54) Shadowbox greeting cards

(76) Inventor: Paula Kay Schmidt, Spring Lake, MI (US)

Correspondence Address: Paula K. Adkins, 14928 Minetta Ave, Spring Lake, MI, 49456, US

(21) Appl. No.: 11/208,170

(22) Filed: Aug. 22, 2005

Related U.S. Application Data
(63) Continuation-in-part of application No. 10/641,451, filed on Aug. 16, 2003.

(51) Int. Cl. G09F 1/00

(52) U.S. Cl. 40/124.09; 40/743

(57) ABSTRACT

A greeting card constructed with 8.5×11 cardstock paper transformed into a 3D shadowbox effect. When assembled, the greeting card will have an image area combined with the frame panels and corners which includes printed matter that creates the 3D shadowbox effect. Features to manufacture include diecuts; which enable the corners to adhere to the right and left frame panel, scores; that enables the card to be folded to the shadowbox, and double-sided adhesive tape; which enables the formation to stay together. Removable adhesive glue dots are for the present invention to stay together in the folded closed position which is for storage purposes. When present invention is in assembled position, it is constructed for stand alone purposes. 8.5″×11″ is the preferred choice, other various sizes in various dimensions may be constructed.

### BACKGROUND OF THE INVENTION

1. Field of the Invention

This invention relates to unique greeting cards, not the ordinary two-fold greeting cards, the stand alone feature is an advantage that no hooks or wall hanging parts are needed.

2. Description of Related Art

The main objective of the present invention is primarily a unique greeting card that can be assembled to view 3D printed matter on the inside and printed matter on the outside with original 8.5×11 cardstock paper, not with cardboard as in cardboard boxes. The printing will cover the entire piece. Corners are not removed which distinctly differentiates the shape and functionality and entails no curved diecuts. No separate tools are needed for assembly, parts will be manufactured on the embodiment with easy directions to make it simple and fun to put together and view on a flat surface. The proposed invention is not any type of wood or plastic frame for hanging purposes or attached to a surface, it is a stand alone greeting card.

In general, the 8.5×11 cardstock paper is common and easy accessible, and only straight diecuts, no removing of paper is needed for this process which makes this a unique, creative, and inexpensive product to be manufactured in the printing industry. The proposed invention is a greeting card is an improvement by providing a new, exciting, and creative way to be viewed compared to the ordinary two-fold greeting cards.

### BRIEF SUMMARY OF THE INVENTION

The main objective of the present invention is to provide a new and unique greeting card that includes printed matter on both sides, unfolds and transforms into a shadowbox and folds for delivery and storage.

To acheive this objective, in accordance with present invention comprises an 8.5×11 cardstock paper combined with printed matter on both sides and assembled to give the present invention a 3D shadowbox effect. Printed matter will cover the entire piece. Five procedures including 4 straight diecuts, 4 scores, 4 double-sided adhesive tape, 2 removable glue dots, and printed directions are needed to assemble the shadowbox. Panels consist of 9 sections to include the image area, corners, top, bottom, right, and left side panels that are folded inward around the image area to create the 3D shadowbox effect. The inside depth comprises 2.125″. The proposed invention stands alone on a flat surface for viewing, not for hanging purposes with wood & plastic frames. The folded size is 6.75″×4.25″, which fits in standard size envelopes. Opposite view comprises printed matter for viewing purposes.

The card comprise professionally printed matter for the 3D effect such as: graphics, text, landscapes, animals, structures,etc. for initial use as a greeting card. Other uses include: Advertising purposes such as: table menus, placecards or signage and blank for teachers to construct crafts and school projects.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 Folded with a 3D shadowbox effect.

FIG. 2 8.5×11 flat unfolded inside position shown with diecuts (1-4), four scores (5-8), 2 removable adhesive glue dots (18-19), corners (10-13) four double-sided adhesive tape (14-17), and 1-4 step directions (10a-13a) on how to fold the card into a Shadowbox, image area (9) and frame panels (20-23).

FIG. 3 8.5×11 flat unfolded inside position shown with arrows (20a-23a) indicating the direction for folding the frame panels (20-23). Also shown with 4 diecuts (1-4) and scores (5-8) for further understanding how folds are constructed.

FIG. 4 Corners (10-13) shown with arrows (10b-13b) indicating the direction for folding.

FIG. 5 Front closed view with printed matter on top outside frame panel (24) and bottom outside frame panel (25) of the embodiment of the invention; also shown including open gap (26) for opening purposes.

FIG. 6 Opposite view shown with printed matter.

FIG. 7 Example of portrait (tall) orientation with printed matter of the embodiment of the invention.

FIG. 8 Example of landscape (wide) orientation with printed matter of the embodiment of the invention.

FIG. 9 Right view of the embodiment of the invention.

FIG. 10 Left view of the embodiment of the invention.

FIG. 11 Perspective view of the embodiment of the invention.

### DETAILED DESCRIPTION OF THE INVENTION

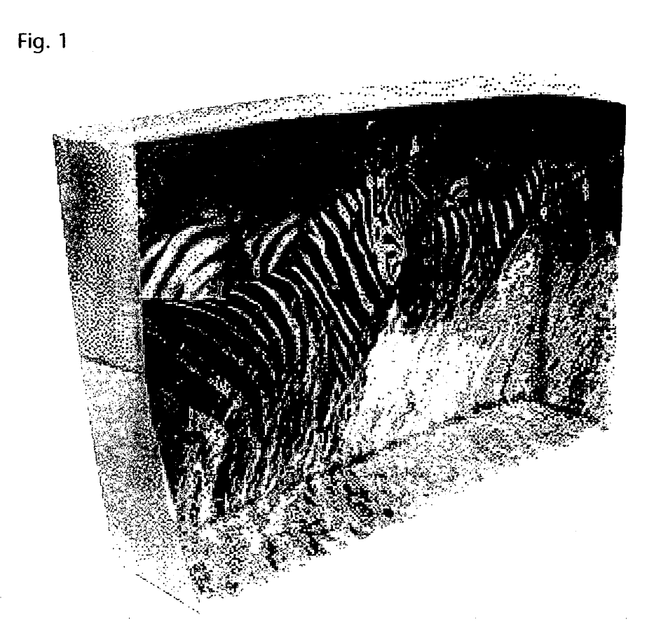

Referring to the drawings FIG. 1, an 8.5×11 size cardstock paper, in accordance with the present invention is transformed into a shadowbox with a 3D printed matter. The present invention is made of 8.5×11 cardstock paper. The image area is 6.75 inches×4.25 in. (9) the inside depth is 2.125″.

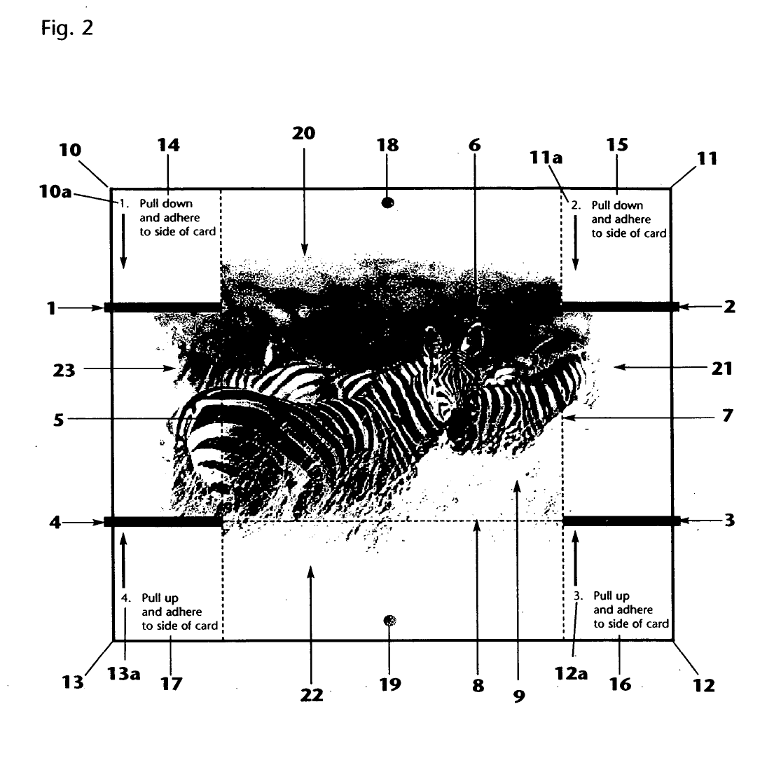

Referring to the drawing, FIG. 2, in accordance with the present invention is 1 diecut (8 pt. gray lines) in each corner with a total of 4 diecuts, upper left side diecut (1) upper right side diecut (2) lower right side diecut (3) bottom right side diecut (4). Enclosed with the scores for folding, left side score size is 8.5″ (5) top score size is 6.75″ (6) right side score is 8.5″ (7) bottom score is 6.75″(8). The image area dimensions are 6.75 inches w.×4.25 h. inches (9). Referring to frame panels, top frame panel (20) and bottom frame panel (22) dimensions are 6.75″×2.125″, right frame panel (21) and left frame panel (23) dimensions are 2.125″×4.25″. Referring to corners comprising dimensions of 2.125×2.125 that are not removed, top left corner (10) top right corner ( 11) bottom right corner (12) bottom left corner (13) 1-4 step directions which show how to assemble card, 1. Pull down and adhere to side of card (10a) 2. Pull down and adhere to side of card (11a) 3. Pull up and adhere to side of card (12a) 4. Pull up and adhere to side of card (13a). In the preferred embodiment of the present invention is double-sided adhesive tape on all corners, top left corner (14) top right corner double-sided adhesive tape (15) bottom right corner double-sided adhesive tape (16) bottom left corner double-sided adhesive tape (17) which enables the panels to stay attached and holds the invention together with a 3D shadowbox effect.

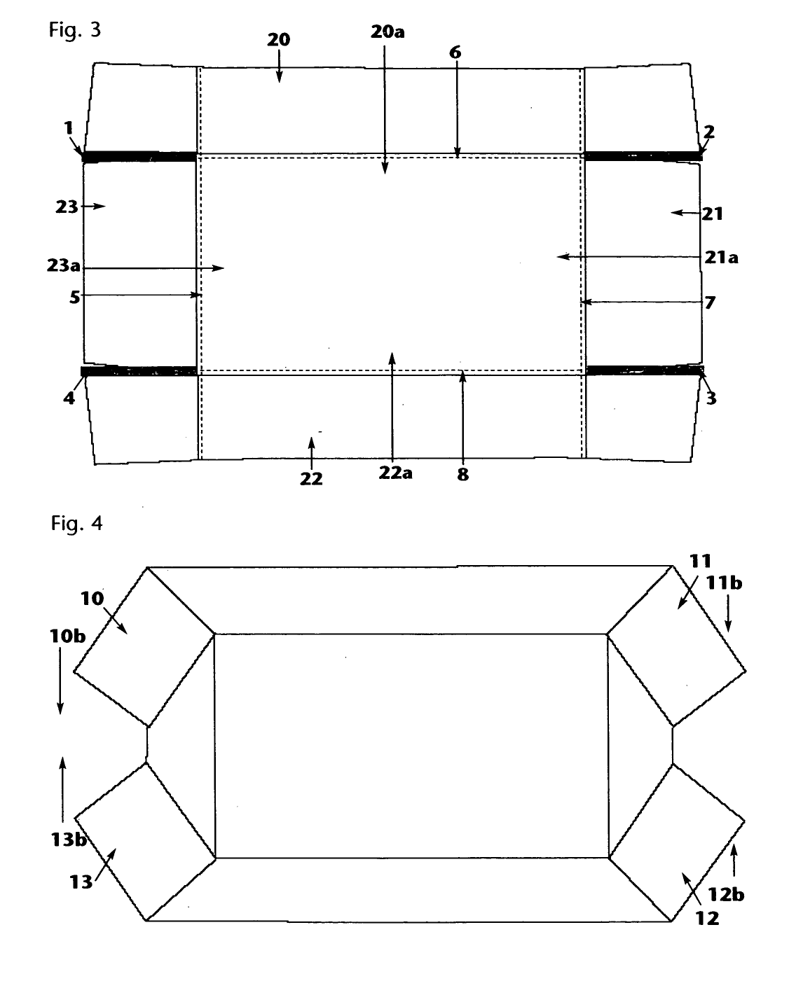

As illustrated FIG. 3, comprises arrows showing in which frame panels are folded, top frame panel (20) folds down (20a) right frame panel (21) folds inward to left (21a) bottom frame panel (22) folds upward (22a) left frame panel (23) folds inward to right (23a). Also shown 4 diecuts (1-4) scores for folding (5-8) to show effect.

As illustrated FIG. 4, comprises arrows showing in which corners are folded, top left corner (10) folds downward (10a) top right corner (11) folds downward (11b) bottom right corner (12) folds upward (12b) bottom left corner (13) folds upward (13b).

With reference to FIG. 2, The present invention has 2 removable adhesive glue dots on the top panel removable adhesive glue dot (18) and bottom panel removable adhesive glue dot (19) which hold the card together in the closed position so the frame panels (20-23) and corners (10-13) are not hanging loosely or sticking up. Furthermore, they can be removed upon opening.

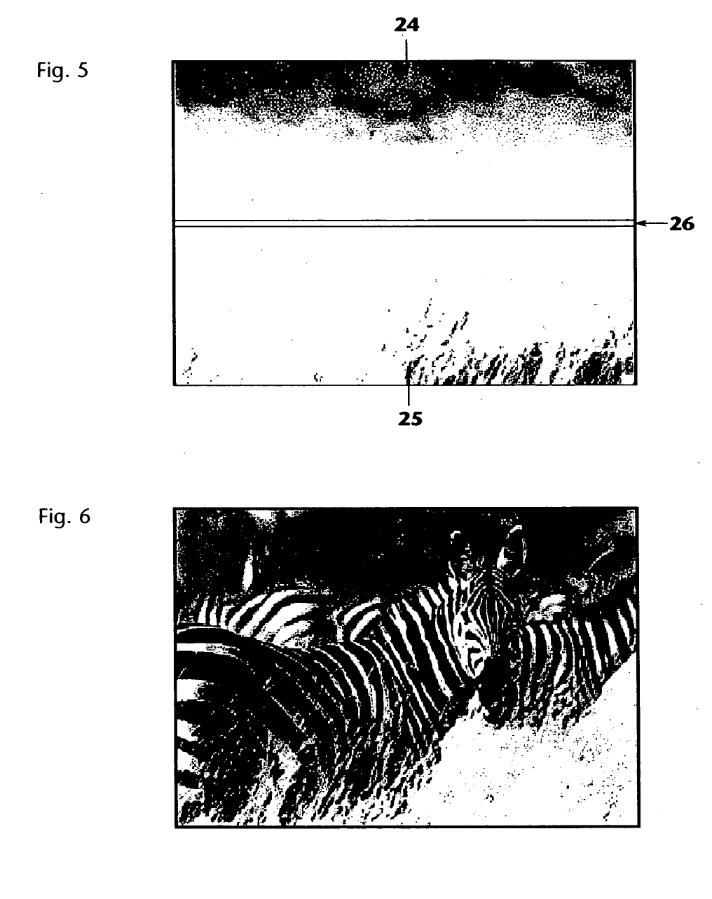

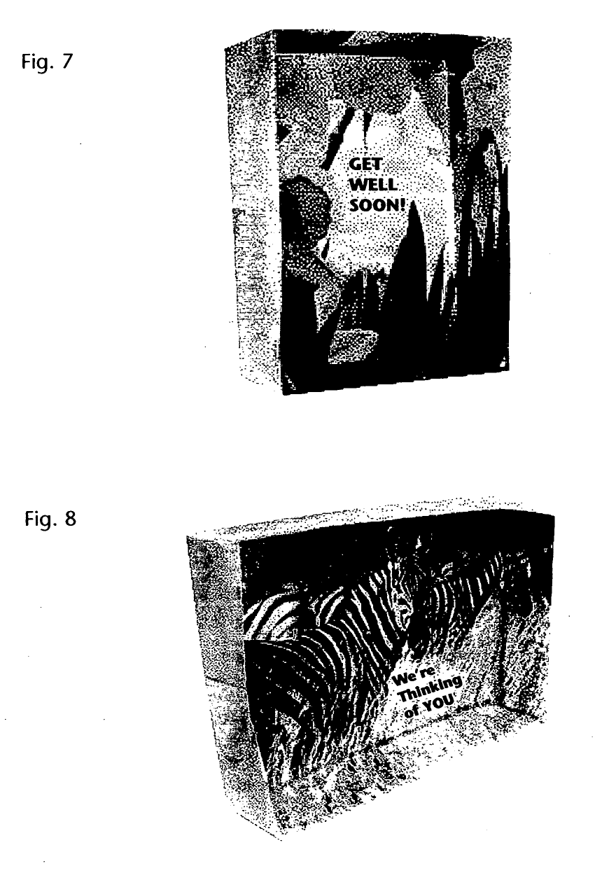

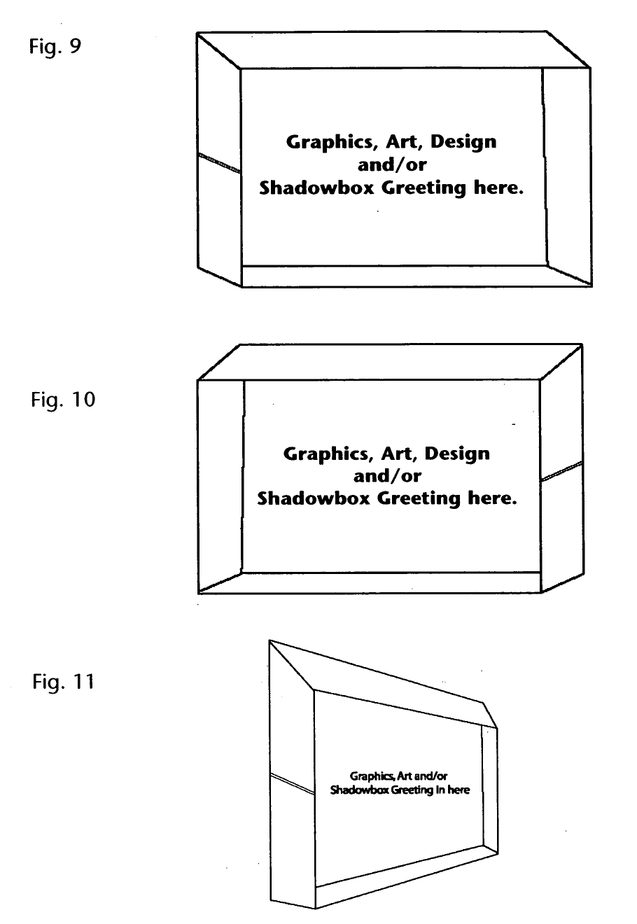

With reference to FIG. 5, shows the shadowbox in the folded closed position. This position is for storage. The frame panels, FIG. 2 (20-23) and corners FIG. 2 (10-13) are folded inward and flat to create the folded closed position. The folded closed position dimensions are 6.75″×4.25″, which fits into standard size envelopes. The closed portion consists of the top panel (24) the bottom panel (25) and the open gap (26) which purpose is for opening the present invention. 8.5×11 is the preferred choice, other various sizes in various dimensions may be constructed.

1. An article, comprising cardstock paper that can be folded to transform into a shadowbox to create a 3D shadowbox effect with printed matter.

2. An article as defined in claim 1, wherein said single piece of cardstock paper includes 9 folded panels.
(a) Top and bottom frame panels
(b) Right and Left frame panels
(c) Four corners
(d) 3D image area panel

3. An article as defined in claim 1, further comprising four corners including:
(a) User-friendly 1-4 step directions for simplicity to be assembled.
(b) Four double-sided adhesive tape that enables the formation to stay together.

4. An article as defined in claim 1, further comprising four diecuts that enables the formation to be assembled.

5. An article as defined in claim 2, further comprising removable adhesive glue dots will be placed on top and bottom frame panels to enable the invention to stay closed in the folded closed position and they can be removed upon opening.

6. An article as defined in claim 1, further comprising four scores located on the inside of formation to enable for easy folding.

7. An article as defined in claim 1, further comprising printed matter that can be printed on both the inside to view the 3D image area and opposite side.
